(19) United States
(12) Patent Application Publication
(10) Pub. No.: US 2007/0177022 A1
(43) Pub. Date: Aug. 2, 2007

(54) Composite Media Recording Element and Imaging System and Method of Use Thereof

(75) Inventor: Craig Mowry, Southhampton, NY (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Mediapod LLC, Wilmington, DE (US)

(21) Appl. No.: 11/562,840

(22) Filed: Nov. 22, 2006

Related U.S. Application Data
(60) Provisional application No. 60/739,142, filed on Nov. 22, 2005.
(60) Provisional application No. 60/739,881, filed on Nov. 25, 2005.
(60) Provisional application No. 60/750,912, filed on Dec. 15, 2005.

(51) Int. Cl. H04N 5/228

(52) U.S. Cl. 348/208.12

(57) ABSTRACT

A composite media recording element is provided. An imaging system and method utilizing the composite media recording element is provided for tandem capture of visual information and positional information related to final images.

### CROSS-REFERENCE TO RELATED APPLICATIONS

The present application is based on and claims priority to U.S. Provisional Application Ser. No. 60/739,142, filed on Nov. 22, 2005 and entitled “DUAL FOCUS,” U.S. Provisional Application Ser. No. 60/739,881, filed on Nov. 25, 2005 and entitled “SYSTEM AND METHOD FOR VARIABLE KEY FRAME FILM GATE ASSEMBLAGE WITHIN HYBRID CAMERA ENHANCING RESOLUTION WHILE EXPANDING MEDIA EFFICIENCY,” U.S. Provisional Application Ser. No. 60/750,912, filed on Dec. 15, 2005 and entitled “A METHOD, SYSTEM AND APPARATUS FOR INCREASING QUALITY AND EFFICIENCY OF (DIGITAL) FILM CAPTURE,” the entire contents of which are hereby incorporated by reference.

This application further incorporates by reference in their entirety, U.S. patent application Ser. No. 11/549,937, filed Oct. 16, 2006, entitled: APPARATUS, SYSTEM AND METHOD FOR INCREASING QUALITY OF DIGITAL IMAGE CAPTURE, a U.S. non-provisional application which claims the benefit of U.S. Provisional Application Ser. No. 60/727,538, filed on Oct. 16, 2005 and entitled “A METHOD, SYSTEM AND APPARATUS FOR INCREASING QUALITY OF DIGITAL IMAGE CAPTURE,” U.S. Provisional Application Ser. No. 60/732,347, filed on Oct. 31, 2005 and entitled “A METHOD, SYSTEM AND APPARATUS FOR INCREASING QUALITY AND EFFICIENCY OF FILM CAPTURE WITHOUT CHANGE OF FILM MAGAZINE POSITION,” U.S. patent application Ser. No. 11/510,091, filed Aug. 25, 2006, entitled: SYSTEM, METHOD APPARATUS FOR CAPTURING AND SCREENING VISUALS FOR MULTI-DIMENSIONAL DISPLAY (ADDITIONAL DISCLOSURE), a U.S. non-provisional application which claims the benefit of U.S. Provisional Application Ser. No. 60/711,345, filed on Aug. 25, 2005 and U.S. Provisional Application Ser. No. 60/710,868, filed on Aug. 25, 2005 and” U.S. Provisional Application Ser. No. 60/712,189, filed on Aug. 29, 2005; U.S. patent application Ser. No. 11/495,933, filed Jul. 27, 2006, entitled: SYSTEM, APPARATUS, AND METHOD FOR CAPTURING AND SCREENING VISUAL IMAGES FOR MULTI-DIMENSIONAL DISPLAY, a U.S. non-provisional application which claims the benefit of U.S. Provisional Application Ser. No. 60/702,910, filed on Jul. 27, 2005; U.S. patent application Ser. No. 11/492,397, filed Jul. 24, 2006, entitled: SYSTEM, APPARATUS, AND METHOD FOR INCREASING MEDIA STORAGE CAPACITY, a U.S. non-provisional application which claims the benefit of U.S. Provisional Application Ser. No. 60/701,424, filed on Jul. 22, 2005; and U.S. patent application Ser. No. 11/472,728, filed Jun. 21, 2006, entitled: A METHOD, SYSTEM AND APPARATUS FOR EXPOSING IMAGES ON BOTH SIDES OF CELLOID OR OTHER PHOTO SENSITVE BEARING MATERIAL, a U.S. non-provisional application which claims the benefit of U.S. Provisional Application No. 60/692,502, filed Jun. 21, 2005; the entire contents of which are as if set forth herein in their entirety. This application further incorporates by reference in their entirety, U.S. patent application Ser. No. 11/481,526, filed Jul. 6, 2006, entitled “SYSTEM AND METHOD FOR CAPTURING VISUAL DATA AND NON-VISUAL DATA FOR MULTIDIMENSIONAL IMAGE DISPLAY”, U.S. patent application Ser. No. 11/473,570, filed Jun. 22, 2006, entitled “SYSTEM AND METHOD FOR DIGITAL FILM SIMULATION”, U.S. patent application Ser. No. 11/472,728, filed Jun. 21, 2006, entitled “SYSTEM AND METHOD FOR INCREASING EFFICIENCY AND QUALITY FOR EXPOSING IMAGES ON CELLULOID OR OTHER PHOTO SENSITIVE MATERIAL”, U.S. patent application Ser. No. 11/447,406, entitled “MULTI-DIMENSIONAL IMAGING SYSTEM AND METHOD,” filed on Jun. 5, 2006, and U.S. patent application Ser. No. 11/408,389, entitled “SYSTEM AND METHOD TO SIMULATE FILM OR OTHER IMAGING MEDIA” and filed on Apr. 20, 2006, the entire contents of which are as if set forth herein in their entirety.

### FIELD

The present invention relates to imaging and, more particularly, to a composite media recording element and an imaging system and method utilizing the composite media recording element for tandem capture of visual information and positional information related to final images.

### BACKGROUND

An important goal of imaging in the digital age, and before, has been to alter the overall data loads related to captured, stored and/or transmitted images. Digital compression is an industry of it's own dedicated to manipulating data volume without altering imaging result beyond acceptable ranges, typically based on a combination of intended display hardware, anticipated average human visual impression, among other factors. Further a limitation of projects captured electronically, be they for cinema, TV, or other intended display venues, is their inevitable resolution and available data limit obsolescence as display and imaging technology proceeds to every higher levels of data managing potential and requirement. For logistical and cost reasons, photographic emulsion capture for entertainment imaging is being replaced in many projects with all digital capture origination. Thus, the vast advantages of proper emulsion record is lost, with selected virtues of emulsion capture being often imitated digitally as a compromise. A need exists in the art for improved systems and methods for maintaining the quality of digital or filmed images while vastly increasing the efficiency of involving emulsion in the capture process. Currently, no system, apparatus or method exists to provide aesthetically superior visuals from a camera or an electronic camera capture module to provide resolution of a final image beyond the limits of resolution allowed by existing technology for example, at the level of a pixel or finer resolution. A need further exists for bringing the application of emulsion in the capture and post production process to imaging that allows for the option of providing a profoundly resolved record of at least enough images to provide this benefit to all images captured, improving on film imitation software and allowing emulsion to provide per-image data results beyond any digital origination option, for years to come, while providing not an imitation, but an actual film record, allowing the discreet color and other visual quality aspects of a real, primary capture record on a selected emulsion.

### SUMMARY

The present invention relates to a composite media recording element and an imaging system utilizing the composite media recording element for tandem capture of information related to final images. The composite media recording elements can be utilized in a system or method to provide aesthetically superior visuals from a camera or an electronic camera capture module to provide resolution of a final image beyond the limits of resolution allowed by existing technology for example, at the level of a pixel or finer resolution.

A composite media recording element is provided which comprises at least two recordable information components operable to store and subsequently provide mutually dependent information related to selected portions of at least one final image, a plurality of the information related to selected portions including image information necessary for recreating the at least one final image, a first recordable information component storing image data, the image data stored in response to aspects of an initial light stimulus related to a visual, the final image being a representation of at least one aspect of the visual, a second recordable information component linked to the first information component, storing non-image data related to the image data, the non-image data related to positioning within a specific final image of the image data, the non-image data encoding selected aspects of the physical position of at least the first image information recording component during response to aspects of the initial light stimulus, and the mutually dependent information provided within the element further identifying the final image relevant to all of the information stored within the element, at least when elements related to different final images are not physically separated to distinguish the different final images. In one aspect, the element is one of a plurality of elements comprising image information related to an entire final image, the plurality of elements presented in a motionless state, relative to each other, during initial storage of image data as a function of reaction to an initial light stimulus, the elements being unfixed particles of a selected size capable of shifting position relative to each other when affected externally, the elements remaining unfixed at least during image capture, wherein elements are provided for exposure and data storage in reaction to the light stimulus and following repositioning of elements storing information following the exposure.

A composite media imaging system is provided which comprises at least two information storing components operable to store and subsequently provide mutually dependent information related to selected portions of at least one final image, a plurality of the portions relating to image information necessary to recreate the at least one final image, one of the information storing components storing non-image data related to the final image, the non-image data related to positioning of image information recorded within an image information recording component of the system, wherein the information storing components are linked to provide the mutually dependent information related to the final image, the non-image data encoding selected aspects of the physical position of the image information recording component during initial image information recording within the recording component, and further identifying the corresponding final image to which the image data pertains, when the components occur within a plurality of components related to a plurality of final images, and a computer operated data managing program to apply the mutually dependent information in creating final images from information stored within the components. In one aspect, at least one of the information storing components comprise photographic emulsion. In a further aspect, the information storing components comprise an electronic recording material, or the information storing components comprise a magnetic recording material. In a detailed aspect, the information storing components are distinct particles of a selected size, the particles occurring in an unfixed state before and after exposure.

In an embodiment, the image information recording component is exposed to light to capture the selected portions of at least one final image, and a camera managing the transport and exposure of the image information recording component, the camera affects the information storage component to store the non-image data related to the mutually dependent information being captured. An exposure area within the camera of a selectable size can affect the volume and dispersal of the components by the camera to and from the exposure area

In a further aspect, the components are provided as aspects of an element, each element operable to store image and non image data and to subsequently provide a computer operating distinct image data managing software with sufficient information to distinguish the equivalence of at least one pixel of image information and to further distinguish a selected final image and placement within the final image where the pixel should be placed, within a final image.

The composite media imaging system can further comprise a camera operating in tandem with a distinct data generating assembly, a stimulus affecting the assembly generates at least information related to the position and shape of selectively distinguished image zones represented within the mutually dependent information recorded by one of the components storing image data, wherein the information related to position and shape pertains to exposure periods occurring when none of the components are being affected by the camera to store the mutually dependent information, the assembly providing intermediary positioning of the zones not available within image data of the element for extrapolating image information not stored within the components, the extrapolating at least involving computer modification of image data based on data recorded by the assembly when image information was not being captured, and the assembly sampling at least one aspect of a full visual related to at least one final image, the sampling occurring selectively more frequently for each portion of the visual than information recorded within the components, relative to the each portion.

A method for imaging comprising is provided which comprises at least two information storing components operable to store and subsequently provide mutually dependent information related to selected portions of at least one final image, wherein a plurality of the portions relating to image information necessary to recreate the at least one selected final image, storing non-image data related to the final image in one of the information storing components, the non-image data related to positioning of image information recorded within an image information recording component of the system, linking the information storing components to provide the mutually dependent information related to the final image, encoding selected aspects of the physical position of the image information recording component in the non-image data during initial image information recording within the recording component, and identifying the corresponding final image to which the image data pertains, at least when the components occur within a plurality of components related to a plurality of final images, and applying the mutually dependent information in a computer operated data managing program to create final images from information stored within the components, the non-image data distinguishing image data relative to corresponding final images and final image aspects to which the image data relate.

An imaging system for tandem capture of information related to one or more final images is provided which comprises an image information collection and recording device for providing stimuli related to a visual to a first media capture module, the module capturing aspects of the stimuli as image information, and one or more second media capture modules for capturing additional information related to aspects of the visual, wherein the first or second module comprise linking data to selectively link distinct information gathered by the modules to inform a computer-operated image data managing program to generate final images related to the visual. In one aspect, some portion of the additional information is captured during time periods in which the first media capture module is not operative to capture information. In a further aspect, the second module is positioned independently from the first module, gathering information not available for capture from the position of the first module, including information related to aspects of the visual at least partially represented within information captured by the first module, the information related to aspects affecting selected distinctions between final images and images represented by information captured by the first module. In a further aspect, at least the second module is one of a plurality of devices operating to generate data related to at least stimuli received by the devices representative of at least one aspect of the visual represented within information captured by the first module, the devices operable to be positioned within an area represented within the visual captured by the first module, including positions intentionally visually blocked by visual aspects allowing the devices to provide information affecting final images that do not reveal visually the devices within the visual information captured by the first module.

### BRIEF DESCRIPTION OF THE DRAWINGS

For the purpose of illustrating the invention, it being understood, that the invention is not limited to the precise arrangements and instrumentalities shown. The features and advantages of the present invention will become apparent from the following description of the invention that refers to the accompanying drawings, in which:

FIG. 1 shows several recording particle “elements” comprised of an image recording media component and a non-image data recording material component.

FIG. 2 shows three groups of processed and digitized image data components of a large number of elements.

### DETAILED DESCRIPTION

The present invention relates to a composite media recording element and an imaging system utilizing the composite media recording element for tandem capture of information related to final images. The tandem capture of information provides visual information and positional information. A composite media recording element is provided which comprises at least two recordable information components operable to store and subsequently provide mutually dependent information related to selected portions of at least one final image, a plurality of the information related to selected portions including image information necessary for recreating the at least one final image, a first recordable information component storing image data, the image data stored in response to aspects of an initial light stimulus related to a visual, the final image being a representation of at least one aspect of the visual, a second recordable information component linked to the first information component, storing non-image data related to the image data, the non-image data related to positioning within a specific final image of the image data, the non-image data encoding selected aspects of the physical position of at least the first image information recording component during response to aspects of the initial light stimulus, and the mutually dependent information provided within the element further identifying the final image relevant to all of the information stored within the element, at least when elements related to different final images are not physically separated to distinguish the different final images. A composite media imaging system and methods of imaging are provided which utilize the composite media recording elements. A composite media imaging system and methods of imaging are provided which comprise, in part, at least two information storing components operable to store and subsequently provide mutually dependent information related to selected portions of at least one final image, and a computer operated data managing program to apply the mutually dependent information in creating final images from information stored within the components.

It is to be understood that this invention is not limited to particular methods, apparatus or systems, which can, of course, vary. It is also to be understood that the terminology used herein is for the purpose of describing particular embodiments only, and is not intended to be limiting. As used in this specification and the appended claims, the singular forms “a”, “an” and “the” include plural references unless the content clearly dictates otherwise. Thus, for example, reference to “a container” includes a combination of two or more containers, and the like.

The term “about” as used herein when referring to a measurable value such as an amount, a temporal duration, and the like, is meant to encompass variations of ±20% or ±10%, more preferably ±5%, even more preferably =1%, and still more preferably ±0.1% from the specified value, as such variations are appropriate to perform the disclosed methods.

Unless defined otherwise, all technical and scientific terms or terms of art used herein have the same meaning as commonly understood by one of ordinary skill in the art to which the invention pertains. Although any methods or materials similar or equivalent to those described herein can be used in the practice of the present invention, the methods or materials are described herein. In describing and claiming the present invention, the following terminology will be used. As used herein, the term, “module” refers, generally, to one or more discrete components that contribute to the effectiveness of the present invention. Modules can operate or, alternatively, depend upon one or more other modules in order to function.

“Recordable information component” refers to an information receiving, storing and readable medium that is an aspect of a larger system related to a specific type of information, interdependent with at least one other information component of the same system.

“Mutually dependent information” refers to image and non-image information linked to affect, at least in part, the proper management of the image data by an image data managing computer operated program toward generating final images.

“Final image” refers to the output image(s) of the system of the present invention, initiated by image data captured and allocated based on stored information recorded and subsequently read from linked system recordable media components.

“Image information” refers to visual, electronic or otherwise captured and readable information, for example, per pixel, specifically presenting color and other related visual data for recreation of visible media.

“Containment” refers to an enclosed, light tight container for providing unexposed media, herein related to recordable media elements comprised of specific media components, and for also receiving such elements, following information recording, such as image capture.

“Photographic latent image recording emulsion” refers to known photochemical recording process of film emulsion being exposed to a visual stimulus, presented in the form of a light, and subsequently photochemically processed and typically “scanned” to digital data for further post production processes.

“Electronic recording material” refers to information holding media, such as magnetic recordable material, for example, as in magnetic tape and related media for holding audio and visual information.

“Unfixed” refers to elements presented as particles/granules, wherein, for example, photographic emulsion may be provided in many free standing particles that may be repositioned relative to each other, moved into selected spaces both for exposure to imaging stimuli and for containment.

“One cooperative aspect of said mutually dependent information” refers to within interdependent stored information related to final image generation by an imaging system, herein a cooperative aspect is image or non-image data, linked and captured specifically for affecting or being affect by this cooperative information aspect, toward manifesting a specific result within at least one final image.

“Physical affecting means” refers to a function of a camera through physical means, such as subjecting to released, compressed gas, or electronic means, such as changing position magnetically, to change the position of elements or recordable granules in relation to each other.

“Electronically affected repositioning means” refers to magnetic or other electronically affected means to move recordable elements, or particles, relative to each other; recordable aspects typically fixed on photographic celluloid or other position fixing (relative to images and portions of images) position.

“Magnetic repositioning means” refers to a magnet sensitive material responding to a magnetically imposed force to shift and/or affect the position of such material and what may be connected to such material, including other potentially non magnetic, recordable media.

“Computer operated data managing program” refers to a computer transform program operable to factor not only image information but related non-image information to create final images that the non-image information comprehensively allows to take form.

“Recordable information components mutually dependent information” refers to image and non-image data that are independently useless as each bit of image information is related to a freestanding recordable particle, thus non-image data must be provided and applied for such image data to be allocated properly to the correct image and image position, following likely randomizing after repositioning of such components in the removal and storage process, following image capture or exposure.

“Final image” refers to an intended final visual result related to the visual selected by a camera operator, thus related to the camera capture image visible to a camera operator and also used to expose (and record) at least one component of the elements of the present invention.

“Distinct data generating assembly” refers to a separate image capture system operating in tandem with the emulsion based capture system, providing consistent ancillary data related to aspects of images captured within emulsion, allowing fewer emulsion based images to be captured in order to achieve the result of more emulsion based final images than original emulsion using images captured, initially.

“Image zone” refers to an area within an image, both provided for capture and present within final images, images zones include at least discernable image zones, such as objects and consistent portions of images. For example, when an image of a human face features blue eyes, an image zone of the present invention may include the consistent blue iris color of the face, thus allowing a computer program to isolate such iris color for subsequent post production use and effects.

A Composite Media Imaging System

The present invention strives to maximize the value of each aspect of data that may be captured, reducing unnecessary large data stores used for perhaps a fraction of their entirety, and expanding options related to even existing ancillary recording systems or camera systems, to provide a new range of functionality to image recording and image storage.

The following examples and embodiments demonstrates the current configuration based on recording and storage of image information, capture devices, and ancillary technology.

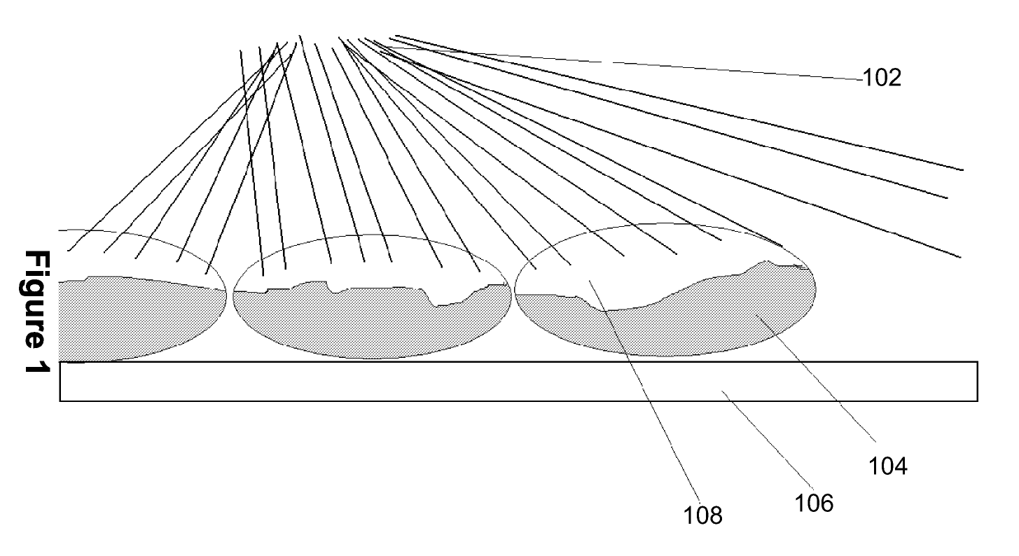

FIG. 1 shows several recording particle “elements” comprised of an image recording media component, 108, and a non-image data recording material component, 104. Herein these components are shown mutually fixed within each independent, unfixed element. These elements are freestanding, (granules or particles are reasonable terms related to these small recordable bits,) and a physically repositioning affecting means places these elements at random within the exposure gate in selected density and general dispersal basis. These elements rest in an exposure gate, 106, herein, but prior to this resting state were, for example, blown into this position or magnetically moved to this exposure gate resting state and following exposure to a light stimulus, 102, the elements are again similarly moved out of this gate area to allow for a new group of elements to be positioned in the gate for a subsequent image exposure. Containments, in one embodiment not unlike the toner cartridges of printers, may provide the unexposed elements destined to the gate, and the exposed and recorded component bearing elements out of the gate, to another containment.

Thus in either containment the elements are randomized. The data recorded by gate electronic recording aspect, such as a magnet, 106, affects the non-image data recording element, 104, for example with specific reference data related to the resting position within the overall surface area of the gate, during exposure. This “where in the gate was I during exposure” data, corresponds thus directly to the position within an “image” provided to the elements, and thus a final image as well, as the image is being provided in the light stimulus provided to expose the image information, in this configuration photographic emulsion, 108.

Non-image data recording material, 104, for example, magnetic recording media, further stores information provided by gate electronic recording aspect 106 related to what image an element is related to, among a plurality of images representing individual distinct exposures to the light stimulus. The exposed elements containment from which the elements removed from the gate are sent and maintained, in this configuration will hold a large number of randomized elements later to be allocated by computing means and a distinct image data managing program, to the correct final image and the correct point, (in this configuration pixel placement,) within the overall image.

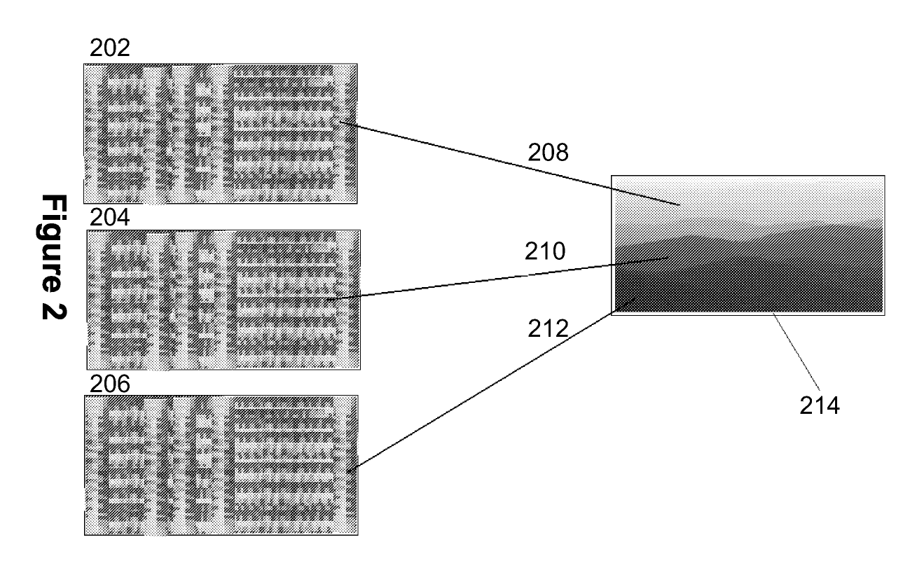

FIG. 2 shows three groups 202, 204, 206, of processed and digitized image data components of a large number of elements, given that potentially an element may hold as little data as that corresponding to a pixel or the equivalent, though larger element component sizes are indeed fine based on the aesthetic discretion of the desired system.

These groups in the present configuration, (though not only option,) are elements spread to a thin, one element thick, layer on a containment surface. This containment herein is to allow for more conventional emulsion processing and digitization. This containment also allows for uninterrupted subsequent reading of the non-image data components of the elements.

Image aspect corresponding reference 208, demonstrates computer and specific program operation to read the non-image data related to element 208, which is pointed out in it's randomized presentation prior to final image creation, and then after non-image data dictates which final image this element pertains to, and what aspect/position within that final image this element represents. Indeed, as demonstrated by elements 210 and 212 and their non-image data record as computer implemented, also occur in the same final image as element 208. This demonstrates the widely randomized elements due to the bulk containment following exposure; again, this containment is a box holding many elements, similar to the color particles occurring within a printer toner cartridge. An important difference is that a toner cartridge provides particles that a computer must indicate where to place, in the creation of a printed image, the toner itself having no such reference to any specific image. Herein, the elements in their particle form, in fact “know” where they belong within a series of final images, by way of the non image data recorded within the appropriate component, (under the emulsion side, which faces up,) which receives such data for storage while the elements are motionless in the exposure gate.

Options for maintaining maximum proper component in position, e.g., up and down, may be achieved potentially by magnetic means, for example, the non-image data side being affected to pull down toward the gate. A sufficient plurality of image information bearing elements may occur without such extra steps, with a proper quantity of elements being provided in a selectively effective dispersal within the gate.

The exposure gate can be of any selected size. By reducing enormously the weight, mass and surface area of raw material, for example, film stock, by eliminating at least the celluloid aspect and providing the unexposed emulsion in a powder-granulated-dust like form, the final image resolution result can be profound. For example, a gate can be larger than those known to 65 mm and all related to 70 mm motion picture systems. If configured in the Key Frame system configuration, wherein a single emulsion image is captured for every 24, for example, through the same visual providing camera lens, the emulsion elements or granules exposed and blown by compressed gas, for example, into a containment for the exposed granules may provide to all final images data thresholds equivalent to, for example, 20 k images and higher. See, for example, U.S. Pat. No. 5,687,011, and U.S. application Ser. No. 11/549,937, filed Oct. 16, 2006, each incorporated herein by reference in their entirety.

In one aspect, a hybrid emulsion and digital originating camera features discreet cartridges similar to large printer-toner plastic cartridges, that like the old super-8 cartridges for film, may be popped on and off following expose of the entirety of a cartridge of such emulsion elements or granules, and each of these potentially surprisingly compact and light cartridges may provide final images many fold more resolved than the heavy, large, cumbersome 1,000 feet of 35 mm film stock, and the single cartridge of the granules may further provide total recording time far in excess of 10 minutes per cartridge, improving on several aspects of emulsion imaging. By contrast, an emulsion originating camera requires a large celluloid emulsion magazine of film, allowing for only 10 minutes of capture time within the overall camera configuration. These elements, or granules, of recordable emulsion which contain a separate record of “where they belong” both in regard to which final image and exactly where within that final image their image data pertains, might be called “smart dust” emulsion, to simply imply their functionality.

Although in one aspect these elements are disclosed as a hybrid media scenario, for each element, in fact a further embodiment can involve only emulsion as both recordable media aspects. For example, image data is recorded on side, or part, of the elements. Recordable emulsion on the other side, or another part of the element might receive a visual or other appropriate stimulus encoding information, for visual recording and subsequent reading. Such a usable code for the image data positioning information, might be a micro bar code or other type of scannable-readable data encoding approach. The issue would be for each element, or granule of “smart dust” to be of a large enough size, however small, to provide sufficient non-image data recording media, e.g., emulsion, to inform the location of the corresponding image information bearing media, however small or large an amount of information that image information may be.

In an embodiment having an emulsion only recordable element, a third component, at the core of the granule or element that is potentially non-recordable, or possibly recordable, may provide a core for emulsion to coat, potentially as a ball or particle featuring only recordable emulsion on its entire three dimensional surface. One benefit of such an approach is that in providing such granules to the camera exposure gate for image capture, there is no question that recordable media is covering the gate area, at least entirely where each element granule occurs. Further the question of “which side is up” is no long an issue, the non-image data being potentially provided through a transparent gate floor where the granules rest during exposure to original visuals-light.

Like the moon which remains dark on one side while being exposed to the sun, where the moon is an example of an enlarged element granule, coated in emulsion with the interior being made of a structure and shape maintaining moon rock, the dark side of the moon might receive an emulsion recording stimulus also, to store a bar code or other information encoding image for subsequent reading resulting in a granule with an image of just a part of the sun recorded on one side and a bar code, for example, on the reverse. Following emulsion processing, the image information can be potentially digitized or otherwise prepared for image display. The information recorded on the dark side of the moon can provide reference to where within a specific final image of the entire sun that element's piece of the sun visual information will be provided in subsequent image data processing and final image creation.

Increasing Efficiency of Film Stock

Like VistaVision technology, film would be provided to the film gate horizontally, making the image size only limited “vertically” by the width of the film (gauge size,) such as 16 mm or 35 mm. In a further configuration, the film stock, (16 mm in this example though 35 mm is equally exemplary,) the film stock itself would not need sprockets; with the registration technology options today, and transport options, sprockets are cumbersome and wasteful of potential image storing media. The present invention, in the 35 mm configuration, would provide an image of a resolution and quality (original) that surpasses any digital originating information capturing means existing, providing the sole option today to capture a visual that only “tomorrow's” digital or other technology will have the ability to approach, during image capture.

Film can be selectively provided by a conventionally positioned film magazine, (of the normal or “disposable” configuration disclosed herein, involving reusable magazines loaded and unloaded by the manufacturer only.). Film could be provided by a horizontally positioned magazine; meaning 90 degrees perpendicular to the normal upright position of film magazines. This precludes additional film management and positioning needs, such as rollers turning the film 90 degrees to get it into the horizontal position for the film gate, and then back 90 degrees again after exposure to replace within a vertical film magazine. This positioning of film stock is useful in the present configuration as described for the present invention.

Herein, the providing of film stock to a film gate which is selectively similar, and selectively variable, in dimension to a rectangular cinema display screen, such as 1.66, or 1.85, (or for the present configuration the width herein will be 2 to 1. The advantage is that, in the case of 16 mm film, the visual can be selectively stored on an emulsion surface 16 mm “high”, or closer to 14 mm if perforations are maintained on one side, and as wide as desired, in this instance, 33 mm or wider, for example. Though, the width would be entirely selective, potentially, by virtue of the virtually unlimited left/right media space per visual.

The present invention, in part, thus provides means for generating 35 mm, for example, wide visuals on 16 mm film stock, and visuals in very close dimension to cinema and HD screening dimensions, requiring little adjustment or distortion in the processes of providing final images to these screens. And, as said, 35 mm film stock would provide the critical means to originate material that surpasses the information capturing/storage means of any digital system, potentially for the foreseeable future. The emulsion surface area will approximately quadruple the visual information per image stored in the film stock. In fact, the use of 35 mm double-sided emulsion film stock and modified 35 mm film cameras, allow for an increase of emulsion area per visual of between 2 and 4 times, or more, than that typical to 35 mm film capture, depending on the amount of overall recording time the magazine of film is selectively reduced to, for example, from 10 minutes.

In one configuration, a single visual is recorded horizontally onto the film stock, which is selectively positioned parallel to the horizon line, relative to the film recording plane, and the lens capturing the visual. The recorded single visual would selectively occupy the space once allocated to, for example, three frames of 35 mm images. The dimension of such a recorded image is selectively very close to the horizontal dimension required for theatrical visuals, utilizing the increased emulsion made available, to a great degree and with minimal waste and “masking” needed to achieve the motion picture screen dimension, such as 1:85 to one, or even more rectangular in shape.

Herein, the use of the space of three typical film frames' emulsion area, would be compensated by the use of the opposite side of the film stock for recording as well, resulting in total recording time of a typical 1,000 foot roll of 35 mm film, 10 minutes approximately at 24 frames per second, to just under 7 minutes, though with a total emulsion surface area per image increased to approximately 4 times what is conventional on 35 mm, if not even greater recording surface area. Maintained as 10 minutes of material at 24 fps, the emulsion surface area over typical 35 mm vertical, single side of stock standard,) still vastly increased without affecting the standard recording time of a “roll” of film.

Again, as films today typically reach a “digital intermediate” stage, the fact that the film exposed is not created with “projection” in mind is logical and inherent to this invention. In fact, sprocket holes are not necessary, in a film transport means based on a selected advancement distance; digital post production means may provide perfect registration of final images, (and matching of images by code or other means,) from one “side” or strip of the film stock and the other. The sprocket hole and other film area may thus be employed selectively entirely in the recording of visual and other data, either entirely in the emulsion or within selected other means provided in the stock, including, but not limited to, magnetic recording material.

After exposure of the double sided film stock, it is likely that after processing of the film, prior or selectively after being “split” and separated into two strips, the lengths of larger horizontal filmed visuals will be digitized by an adapted “data-cine” or “telecine” apparatus capable of scanning the larger film frames; following digitization, these “negatives” on the thinner strips, relative to conventional 35 mm film, will be stored then for possible future “re-scan” when increased scanning and data storing means exist, beyond what today's technology can offer. . . . These larger filmed frames thus contain the additional image data for future application, relative to conventional 35 mm productions, or conventional digital cinema, e.g., digital origination, available today.

In a further aspect, the present invention provides selectively mirroring or related optics/image diversion means may relay the lens image to one film gate on one side of the film stock, for recording, and then the other gate, in a staggered delivery, prior to the film stock being advanced to the next horizontal frame of unexposed emulsion; in this configuration, the film stock would thus need only be advanced twelve frames per second, to achieve the 24 fps overall recording, both sides having been utilized. The image diversion means may selectively provide all, rotating mirroring or other means, or part of the lens image by beam splitting means, to each of the respective larger film gates. The lensing and hardware would be naturally adapted to accommodate the selectively width variable film gates which now are closer in size to the old “70 mm” film gates, in size,(which recorded visuals closer to 50 mm in actual recorded image width, depth of field and related photographic aspects selectively being affected by the change in “gauge size” or gate size, to the degree that optics and related hardware would need to accommodate same.

The present invention thus provides means to expose both sizes of film of a selected gauge size, with the use of 35 mm film, for example, providing filmed visuals of a resolution far superior to typical 35 mm filmed recordings. These film recorded visuals would selectively provide more information per visual than conventional digital systems can deliver today, thus providing filmed visuals potentially more compatible with digital (and other imaging systems) of the future, as the larger emulsion area holds a vast amount of visual information, surpassing image origination data typical to even the newest digital cinema options.

Should the 16 mm format be used to originate under the present invention, a final “print” from the “horizontally exposed” images to a conventional 35 mm film stock in the conventional direction and format, might be affected by printing means to alter the exposure level and/or color aspects as the visuals are “printed” onto another film stock, such as an “internegative” stock.

The goal being, to end up with a high quality negative of the “larger” gauge size, embodying aesthetic adjustments chosen in the digital domain and also benefiting from the unconventional use of the smaller gauge format, for example, 16 mm, to achieve visuals of, or nearing, those typically recorded by the larger gauge size, conventionally.

In total, the present invention provides means to originate with film using “smaller” lighter equipment while resulting in the comparable “original negative” surface area, and resolution and quality, to larger film gauge bases. Further, the present invention allows for origination with familiar 35 mm systems, including the lensing and housings familiar to the industry, while resulting in visuals with quality and resolution comparable to “70 mm” originated visuals, thus achieving the goal of surpassing the amount of visual information captured and stored during original photography of any digital system presently available, even if the initial use and screening means does not employ larger than existing digital technology, such as 2 k or 4 k, as the “existence” of an original “negative” that future technology can extract vastly more visual information from, for example, 20 k, renders that project “future ready” and in fact more in synch with the future of digital cinema and television than any existing digital origination means may provide.

With the enormous expense of making and releasing films, the availability of an original negative that may provide future applications in synch with the capture devices of the future, increases the potential for that project to be displayed more in the future, should systems upgrade to larger information management/display means, without significantly changing the capture, weight and expense aspects of originating on film.

Further, the staggered relaying of the lens image to one side of the film emulsion and then the other allows for the double sided film emulsion to be advanced once for it's entire length, without employing the other options of reversing the direction of the film, or employing a continuous “loop” and reversal-of-side or twist, means to allow the camera to expose one side of the stock entirely and then the other, entirely. However, the present invention does not preclude those or other options being employed in the horizontal exposure of the film stock, on both sides.

In another configuration of the present invention, conventional film stock of any gauge size, is exposed horizontally. The “magazine” of film storage means, often placed behind, or above the camera's mechanism and film gate, is selectively placed behind the camera, as is common in cameras by Arriflex and Aaton; this positioning is however not essential.

The film in this storage, e.g., magazine, would be horizontal not the typical vertical position, and thus parallel with the horizon, if the shot being captured were of a sunset/horizon for example. Thus, the film would enter the camera mechanism or film gate area as with Arriflex cameras, in the horizontal position. In the case of 16 mm film, the sprocket holes on single per stock, would selectively be occurring on top, or on the bottom of the stock, as it is presented to the camera film gate for exposure; without necessity, the present invention positions these sprocket holes on the bottom.

In the case of typical 35 mm stock, the sprockets occur on top and bottom; the present invention in one configuration involves film stock with only one side bearing sprocket holes, or in a further configuration, no sprocket holes as the digital domain eliminates the issue of registration, such subsequent picture matching occurring selectively in digital post production reducing concern over exacting position of film stock through the mechanism and film gate of film cameras.

The optics of film camera(s) would be modified to be similar to those of a larger gauge camera, as the present invention provides for exposure of emulsion areas typical to the “next step up” in gauge size: 16 mm cameras providing more like a 35 mm exposure emulsion area and 35 mm cameras of the present invention providing a remarkable gate and emulsion exposure area potentially surpassing that of typical 70 mm stock exposure by known 70 mm film cameras (and 65 mm, and others related to this large gauge size.)

The distance of optics to the film plane as well would be adjusted to allow for proper exposure of the larger provided emulsion surface area.

The width of the exposure area would be, selectively variable and, typical to high definition television display, thus the ratio of width to height would selectively be the same or similar to that of the eventual intended display systems/units. However, though an important configuration of the present invention is for this important dimension (such as with plasma TV monitors providing high-def content,) the width of the gate size could be variable in the present invention. Thus, the actual amount of film intermittently moved through the gate area would change selectively based on the display system, or setting, intended for the material, potentially. For example, if the material is destined for conventional TV display, a 1:33 to 1 ratio of film would be exposed so the potential of the present invention in the 16 mm camera configuration, would expose a negative image of approximately 14 mm×18.6 mm. If the intended display were high definition TV, the negative exposed and amount of film moved into the gate area would change to be approximately 14 mm×23 mm; and if the eventual display were a theatrical screen as wide as approximately 14 mm high×33 mm wide. These dimensions are important, as with the theatrical screen shooting intent, it is important to note that the present 16 mm configuration provides a significantly larger emulsion area for material that actually makes it to the screen, than today's typical 35 mm cameras, which for wide screen are often limited to capture emulsion dimensions for “live” material of approximately 14 mm high×21 mm wide.

In this configuration, the film gate is in the same position basically, as all film cameras used conventionally. In a supplemented version of this configuration, the film gate could occur horizontally, or otherwise, to allow for the second film gate of the other configurations of this invention, wherein both sides of the stock are exposed.

Though in both versions, the single and double gate versions, the selective variability of the exposed frame width is a one aspect of the present invention, changing literally the length of film advanced into the film gate based on the desired width of negative selected. In this way, film negative is never “cropped” and wasted as oft happens with 35 mm photography, wherein cropping vertically allows for the negative dimension to match the very rectangular shape of some film screens; the present invention allows thus for a superior image quality for such screens, on 16 mm for example, than 35 mm is capable of rendering via the currently configured camera systems.

The Film Stock and In-Camera Configurations

Embodiments of the invention that need not be in one particular configuration, include the double sided emulsion film stock and the double side exposing film camera:

The double film gate disclosure of the present invention and filings, may selectively not be perpendicular to the lens surface area, but positioned as typical film gates occur, though the two gates may be staggered (above and below, or at different points within the camera,) allowing for optics and selectively mirroring and/or other lens-image diversion means, to relay the lens image in it's totality, or a portion of it selectively if beam splitting is employed, to one gate and then the other.

In this configuration, reference information can be imprinted visually or by way of a data track or other recording means, to allow selectively the frames of film representing sequentially captured visuals, whether one exposed immediately after the other, or simultaneously, or later. Thus, film stock may undergo looping or other related in-camera management, via rollers and related components common to film cameras, in order to provide the reverse side of the same length of film stock for exposure. See U.S. Pat. No. 5,687,011, incorporated herein by reference in its entirety.

The length of double-sided film, e.g., emulsion occurring on both sides as it moves through the camera, may be exposed in a staggered frame-by-frame approach, e.g., an image on one side, then the other and then advancing the film to the next unexposed portion of stock, or the entire length of film may be exposed by way of a single gate system, whether parallel or perpendicular to the image capture lens, or otherwise positioned, with the reverse side of the same length being provided via film direction reversal means, or continuous loop and mechanical turning of the film stock to provide the second side after exposure of the first, or other such physical approaches for providing same.

Also, it is important to reiterate that the double sided film stock can be employed as a recording “time” enhancement, not quality related, allowing for the two sides of the film stock to be recorded as discussed above, with a conventional “gate” and exposure dimension to typical film cameras. The advantage therein being that recording time is exactly doubled, and conventional digitizing and film printing and processing machinery is set to deal with those particular exposure sizes, the vertical position of the images and the number of “perforations” per visual (or sprocket holes,) thus requiring only the issue of the potentially (selectively) thinner strips of film, if double sided film is “split” in to two strips prior to digitizing and/or processing and/or film printing, etc. An objective of the present invention is to provide film stock, (whether single or both sides emulsioned,) that is the same or similar weight and thickness to the stock that cameras typically manage today, though this is not essential or a limiting aspect.

Regarding the film stock of the present invention, in the single sided configurations of the horizontally provided film stock, one configuration would eliminate sprocket holes/perforations, allowing the film to the moved through the gate through the motion of the rollers (holding the stock and/or within the camera,) to allow the extra emulsion area lost with such sprocket holes to become media/image recording space. However, the present invention also works with the configuration of using typically available film wherein such sprocket holes occur. As both options may be provided in the future, the option of selectively adjusting the exposure area both with regards to width and height would be selectively provided in one configuration, to allow optimal use of emulsion area provided by a given stock's composition, for example, with or without perfs.

Therein, it is selective that film stock of the present invention that lacks sprocket holes may be transported roughly by the machinery of the camera, with subsequent perfecting of the “registration” of the pictures to each other occurring in the digital domain, or selectively markers occurring optically or on other data storage means, as an aspect of the film stock, may allow for laser or otherwise guided registration and film transport, such guidelines or markers also providing the means for a variable transport camera of the present invention, those moving a selectively adjustable length of film into a selectively wide gate area, to precisely quantify the transport of an amount of film per exposure.

Again, such cameras may operate ad variable speeds as with conventional cameras, however in the double sided configuration, wherein 24 fps is the anticipated final “digitizing” or display goal basis, even if altered in the video/digital real for digital display, the film need only be moved 12 time per second, in the configuration where the exposures are staggered (side 1, side 2, side 1, side 2 and so on), if the goal is to achieve a conventional 24 visuals per second of time.

The double sided, two sided emulsion coated film stock can be produced in a variety of configurations. In one non-limiting configuration, two lengths of “thinner” film stock are married to create a length of film stock that is a conventional weight and thickness for cameras, despite the emulsion occurring on two sides. Other configurations of doubled sided two sided emulsion coated film stock can be produced. Further, selectively, an opaque partition between the emulsions on each respective side, such as a white celluloid, and/or plastic, or other reflective material, can provide that in the digitizing stage of the double sided emulsion, the film stock may be maintained, and created as, a single strip, as with conventional film stock: It would thus mean that in digitizing light would be reflected back from the film emulsion, based on the opaque later behind allowing for such reflectivity, to allow for digitizing as with reflective art, rather than as with light typically being projected through the film stock.

If digitizing in this way were of sufficient quality, relative to the projected approach, the need to “split” the film for separate digitizing, or printing or other use, of each separate strip would be avoided. The film could be digitized, both sides, one after the other, or simultaneously by a digitizing unit configured for that purpose, and maintained and stored as a single strip of selectively the same thickness and weight as conventional stock, with the only difference being that this double sided stock contains twice the image recording area means.

In the management of visuals shot in this “double sided” configuration, data referencing, e.g., visual or other magnetically or otherwise recorded data, on the film itself, each side, would selectively allow for all stock to be scanned, and even though the “second strip” might be digitized some time after the first, in the “split” stock two-sided configuration, the time-code or visual reference information (the “data”) would allow for computing means to automatically assemble the visuals in digital form into their proper sequence, as they were captured. Thus, though not limited by this, the present invention is most geared to film capture of visuals destined to be, at some point, digitized and/or managed in the digital domain; even if eventually returned to film for display or other purposes.

Quality and Efficiency of Film Capture

Key filed frames can be exposed through the same lens as video/digital material, being used subsequently in the digital “recoloring” of that digitally originated material.

Aspects of the present invention are not limited by the term video, as digital visuals and digital visual data is indeed applicable, if digital origination was employed, e.g., for the “high definition” material. Further, high definition images stored on tape, does not preclude or is not limited in the present invention or that invention by how the digital (and/or video) images are stored, on tape, in a “drive”, or on disc. The issue is the selectively simultaneous exposure of video and/or digital material and filmed visuals of the same or similar visuals (through the same lens, or lenses selectively positioned to capture similar material.

To provide new options affecting the quality and efficiency of film capture, herein is disclosed the selective further aspect of the system or method of exposing filmed visuals on any gauge size in conjunction with video and/or digitally originated images, and captured through the same lens or selectively by lenses separate but positioned for use by the present invention.

In one aspect, the film gauge is 16 mm film and the video media is digital high definition, e.g., digital data, and/or video data captured by CCD or other electronic capture means.

In the 35 mm configuration of the present invention, regardless of whether the film is exposed conventionally, horizontally, or on one side of film stock or on both sides of double-sided-emulsion on both sides-film stock, the opportunity is to capture, selectively, original visuals containing a vast amount of visual data surpassing today's standards, even surpassing old 70 mm film capture systems. Again, this is relevant for potential future digital or other visual means that may utilize the extra visual data of this large negative area, such as future systems able to manage “20 k” or higher.

A further aspect of the invention provides means to capture visuals on 16 mm that surpass 35 mm conventional image quality, and 35 mm images that surpass any digital capture for cinema means conventionally available.

Herein, the selective option of capturing fewer than 24 fps of film originated images is provided. Further, the “video tap” is in fact a high-definition video (and or digital) capture and storage means. This accomplishes the dual goal of enhanced preview on set during capture, by way of the digitally captured visuals, providing material at conventional digital rates such as 24 fps, or 29.97, or 30 or other known options employed for digital origination. Further, the digitally originated visuals, would contain cross reference image data related to the filmed visuals, e.g., selectively captured through the same lens, by way of beam splitting and/or image diversion means, such as mirrors and known optics, for later cross referencing between digitally originated (and stored) visuals and the film originated visuals. Magnetic striping or visual reference, or other data recording means on film, may be provided to allow for easy and selectively automatic cross referencing between the two types of originated visual material. In this configuration the film camera is primary, the digital unit relative equal or secondary with regards to “on line” capture material.

The further use of the approach is expanded, to acknowledge filmed visuals not used solely in “re-coloring” digitally originated material. The combination of highly resolved filmed visuals, exposed by the usual means and with the usual care, typically handled by a director of photography, with the secondary capture and storing of digitally captured material of the same scenes, and or visuals, selectively at the same or similar points in time.

The expanded purpose, herein, involves the desirable aesthetic and post production use of film originated material, potentially different from re-colored digitally originated material. Further, “morphing” and related image extrapolation e.g., inferring, technology may provide proprietary software to allow for the following:

Filmed material captured to be done so at a lesser frame rate than is conventional, such as 12 fps, or even fewer frames per second. Present technology employed as an aspect of the present invention, would thus allow for extrapolation of the “intermediary frames” not captured by film, to occur by way of digital approximation, based on inference of the digital data's position and shifting between available “film originated” frames, once digitized.

Further, exacting means to provide this “morphing” or creation of inferred visuals between available filmed ones, by way of the high definition digitally originated material. Therein, visuals indeed exist, highly resolved, to potentially aid in the creation of the inferred, and/or morphed visuals, which were not filmed, but are created from the filmed visual elements nonetheless. The positioning of aspects of the filmed visuals would be entirely referenceable within the digitally captured visuals, which doubled also as the visuals used for on-set preview, and initial editing.

Indeed, all editing of a project can begin and even be completed using the digitally originated materials, prior to receiving the filmed visuals, after processing, in digital form. In the “final edit,” or creation of the digital master and/or related intermediates, the digitized filmed material would “replace” the digitally originated material, selectively as a final stage of post production, prior to selective additional adjustments of the visuals by a look manager system or related digital “look” refining means.

Visual code cross referencing data, carried through from the film negative to it's digitized version, relative to the high definition originated material, would selectively allow for immediate visual cross referencing exact to each frame.

Thus, several goals are accomplished:

16 mm film may provide conventional 16 mm and super 16 mm visuals, vertically exposed, either on one or both sides of film stock selectively, which may be exposed at a selectively slower frame rate, e.g., 12 fps, to allow for a longer record time from a single roll of film stock. Further, horizontally exposed visuals may provide emulsion areas per visual as large as approximately 14 mm×33 mm, surpassing typical 35 mm film origination quality, and selectively without changing, or even while increasing the overall record time a single roll of 16 mm provides.

Selectively few filmed frames may actually provide a sufficient amount of filmed image data to infer digitally, with or without use of the digitally originated material. Further, the disclosure of dual film gates, allowing for exposure of both sides of a two-sided-emulsioned film stock, with optics relaying the lens image first to one gate, and then the other, would selectively double the available visual data recording area provided therein. In total, the present invention would selectively allow for a final result, in digital form, or other visual form including film final, of filmed visuals surpassing 35 mm conventional filmed quality and/or resolution, while selectively maintaining all or even increasing the typical record time provided by a roll of 16 mm film, such as approximately 10 minutes. In one configuration, the record time would at least be doubled to 20 minutes per roll, while gaining the approximate 35 mm filmed quality emulsion area from a 16 mm stock; digital extrapolation means and/or double sided film stock aiding the effort.

A further benefit of the horizontal exposure variable film gate and film advancing quantity would be selectively employed, allowing for filmed visuals of any gauge size)to maintain the full vertical available recording area of a film stock, such as 35 mm if 35 mm sprocketless film were provided, while adjusting for the display ratio (1:33, 1:65, 1:66, 1:85, 2:35, all to 1) by providing a selectively larger (wider) amount of film stock for exposure per visual; thus affecting the length of each “advance” of the film stock, selectively intermittently, to provide the next portion of unexposed stock to the selectively varied film gate. Little or no waste occurs, or masking then, in providing a film stock ratio specific to a display ratio, all rectangular display systems, no matter how narrow or wide, being potentially serviced by visuals exposed based on the same screen ratio.

For 35 mm film stock, one configuration involves, as with 16 mm camera configuration, film stock that no longer involves perforations/sprocket holes. However, accounting for same presently and still claiming the improved image recording area of one configuration when that is available, the present invention and the above means described, would allow for film capture of visuals superior to the old 70 mm film originating, from 35 mm film, while not reducing, in fact selectively increasing, the total record time provided by a 1,000 or other size or length of 35 mm film. Thus, the filmed negative, of 24 fps or fewer, may be stored and referred to in the future when that negative may provide image data for higher information management systems, such as 20 k or higher, which present digital information would not be able to supply with visual data utilizing the capacity of such future, standard systems and options.

Further, digitally originated material may be employed in affecting the final digital material, it's look or other aspects, selectively; the digitally originated material may provide improved resolution or aspects to the filmed images, inherent to such electronic capture, selectively able to be contributed to digital visuals created from referring to both digitally originated and film originated material.

So, in a further system configuration, a firm(s) can provide the film stock for the system, whether conventional or adapted from what is typical, the digital “look management” and frame “inferring” or morphing software, the digital cross referencing between digital and film originated visuals, selectively exposed through the same lens selectively at the same or similar times, means to process and scan selectively horizontally exposed film frames of potentially different widths, among other necessary aspects of configurations of the present invention.

An incomparably efficient film camera would thus, in certain aspects, provide filmed material for the best present and future resolution options, with the ideal “video assist” in the form of high definition digital material captured through the same lens as the film. The end result being a minimally changed shooting scenario and equipment scenario on-set, an improved or at the least minimally affected shooting time per quantity of film stock, and an uncompromised or improved final “film originated and film look” digital result, selectively equal to or superior to such results from typical film systems of the next “larger” gauge size, (16 mm providing 35 mm quality, 35 mm providing 70 mm quality, etc.)

The present uses do not limit, though, the fact that high quality filmed and digitally originated material then exists relative to the same scenes and production; options beyond what have been stated exist and will exist relative to the existence of superior film negative and high definition digital material relative to the same shots or lens visuals.

Whether applied to conventional film stock and conventional vertical exposing and frame sizes, or adapted stock and exposure approaches, as described herein, embodiments of the present invention improves the visual quality and/or efficiency of film capture.

Horizontally Positioned Film Gates

In providing the camera lens image to the film stock, herein a horizontally positioned gate, or gates, has been disclosed in creating options to increase image capture quality options. In a further aspect, optics (and/or mirroring means) may “turn” the lens image 90 degrees before providing it to a vertically positioned film stock, as with today's conventional film cameras, wherein a fixed or variable film gate, where the width of the exposure area on the film stock is selectable, is not in the usual horizontal position relative to the lens and scene being captured, but offset 90 degrees.

Thus, film magazine(s) of cameras need not be repositioned and film stock need not be twisted or repositioned to achieve a horizontal film plane relative to the lens, as disclosed previously. Herein the lens image visual (light) is turned and/or bounced to be relayed at a 90 degree offset, as occurs with flatbed film editing tables, the film stock image being turned for display on the projection monitor. Again, the optics of a 16 mm system would be that of a 35 mm camera, or other option, including custom made option, to allow for the larger image area relay to the film stock. Again, the image area for exposure on the film stock would exceed that of the “next up” film gauge, as the film would be exposed horizontally on the stock, relative to it's length, to allow for the image height to be limited only by the gauge size, and the image width to be variable, limited only by the selected image ratio, based on selected final display system/option dimension or ratio. See drawing. In essence, the film gate is turned 90 degrees, is optionally of the variable type, as disclosed herein, and is provided with a lens image that has also been turned 90 degrees, to allow for proper exposure of the lens image in the ratio/dimension desired, though on film stock horizontally, as opposed to the typical film systems of today, wherein visuals are exposed vertically. The width of the visual is limited only by the gauge width of the film stock.

Hybrid Digital and Film Camera

Yet another embodiment related to the present invention is a hybrid digital and film camera, utilizing conventional 16 mm negative motion picture film stock. This in no way limits the application of the following with regards to gauge size, and it should be noted that sprocketless versions of any film gauge size, (or sprockets on only one side as with single perf stocks,) would allow for proper application of the present option(s):

Herein, the conventional film gate (vertical) associated with 16 mm motion picture cameras would be replaced by a modified “double sided gate,” which would accommodate two strips of 16 mm stock, emulsion out, facing the lens image, allowing the sprocket holes of the stock to be on the “outside” of both strips, thus also on the left and right sides of the double gate.

Separate, linked film transport means, would allow selectively one side to move down, while the other side or strip of film would move up. Intermittently, unexposed portions of film stock would be “side by side,” with only the very small strip, or line, between the separate stocks interfering with the capture of the lens image.

Selectively, the lens image delivered to the side-by-side strips of emulsion, would occupy 4 conventional 16 mm or super 16 mm frame areas. Thus, a single visual would be delivered to (selectively) approximately an area of emulsion, comprising the two separate strips, of more than conventional 3 perf 35 mm image recording means/area; in fact, the actual area provided selectively by the present invention is 15 mm high by 26 mm wide, two vertical frames/perfs per strip, side by side, providing an overall area of 364 square mm. This is an improvement over the emulsion provided by 35 mm 3 perf (1:85 to 1 image ratio) of over 5%, selectively.

Employing the “key frame” approach to utilizing filmed frames, whether captured as a single image or as a composite of separate captures, to improve resolution and/or aesthetics of digitally captured material, the present invention would allow 16 mm film cameras, with selected modifications, to capture the image data necessary to infuse digitally captured visuals with over 6 k of per-image data.

Proprietary software would allow for such image captures on two strips of emulsion, to be referenced by time code or other image coding referencing means, for application to the respective selected digitally originated visuals, captured selectively through the same lens at, or in and around the time the key frames were captures. This digitally originated material may be at a normal frame rate, such as 24 frames per second, selectively. The selectively flickerless and selectively high-definition digitally originated material, may selectively provide the image-zone (aspects') positioning data for proper allocation of the filmed key frame image data, in the creation of final visuals, (24 per second for example,) which embody in excess of 6 k per visual image data, as a result of application of key frame data to more than one digitally originated visual.

Herein, magnetic and/or visual coding means on the film stock, (selectively restricted to the film area to the thin side or edge of the perforated side of stock, or to other areas not restricting the emulsion area for image recording will provide cross referencing data for easy and/or automatic referencing between digitally originated visuals and filmed key frame visuals, for post production applications.

Thus, the film stock in one configuration is from a single roll of unexposed stock, as with conventional film cameras, the lens image is selectively diverted to allow for recording of the full lens image by a digital capture and recording means, with the same lens image providing the full lens image for selectively exposure as a variable, e.g., 1:33, 1:85, 2:35, ratio image on film stock selectively providing an emulsion area larger than conventional 35 mm capture, e.g., for cinema.

This film stock would undergo a repositioning, e.g., by rollers of other means, after initial exposure by the left side of the gate, allowing for the “flipped” stock to be returned for exposure by the other side of the gate, with the “emulsion area” still facing out, toward the lens image. Selectively, “double sided film stock” could allow for film to be returned to either side, both sides containing film emulsion, with a final result of a single roll of film stock having both sides full exposed, embodying latent images within emulsion on both sides of a single celluloid strip. In the simple configuration, conventional single sided 16 mm stock is described.

Selectively, each gate “side” would expose on, for example, two conventional “frame” areas, or emulsion related to two perforations of stock, and advance skipping the next two, as the other side can use that stock to expose the “other side” of the lens image, ongoing, intermittently. Time code reference for each and every perforation, or image portion, would make this jumble of visual parts easily sorted and allocated in post, automatically, selectively after a project has been edited from the digitally originated visuals, and final visuals are selected for affecting with the digitized filmed key frame visuals which are of improved resolution and/or aesthetic appearance.

In further aspects of the present invention, provides increase in visual quality, and also improvement in efficiency. As a single key frame per second, with appropriate post-production software, may be used to affect at least an entire “second” of digitally originated visuals, such as 24, a single roll of 16 mm film typically providing only approximately 10 minutes of recording time, may in fact provide now 60 minutes, selectively, while also providing a final film originated “look” result of 4X the normal resolution provided by typical super 16 mm systems. Selectively, more key frames per second may be exposed, and/or frames of different overall emulsion surface area, providing more or less recording time per roll of film. Should a roll provide 6 key frames per second, or one for every 4 digitally originated corresponding images, the recording time of a single roll of film still is not less than a conventional 16 mm camera and recording system, at 24 fps.

The present invention can provide the film stock to a conventional “take up” spool, changing the mechanics of the film camera as little as possible or selectively necessary; the stock having traveled through the double sided gate twice, being the key modification and mechanical modification. Further, in a modified film camera, two rolls or two separate strips of film may be delivered to the double gate, allowing separate rolls to literally be transported in the same direction through the double sided film gate. In this configuration, the advantage would be the amount of film stock overall, increasing recording time even further, the fact that smaller stock, for example, 16 mm as opposed to 35 mm, may provide images with higher resolution than conventional capture by 35 mm stock, and the further advantage is the elimination of the need for “twisting” the stock through various repositioning means to allow it to be exposed, and redelivered to the other side of the double sided film gate, for re-exposure, selectively in the same direction (up to down,) as before, or in the opposite direction (down to up,) before return of the exposed stock to the take-up reel.

Again, this system relates to a hybrid camera, selectively, wherein a digital image capture means captures through the same, or an adjacent, lens full conventional image captures at a selectively normal frame rate such as 24 fps, while the double-sided gate provides selectively very high quality filmed “reference” or key frames of the same or very similar lens image/visual.

It is very important to add, that the application of the horizontal aspects of film gate and film emulsion recording would provide an enormous gain in resolution, regardless of the film gauge size involved. Describing this improvement relative to 16 mm stock, a 1:85 ratio intended display dimension, and thus image capture dimension, and wherein one key frame, from two strips of the same length of celluloid/stock, is generated per second:

The emulsion area exposed, with the two strips positioned now as “top and bottom,” instead of left and right, is increased to selectively 24 mm high×45 mm wide, each strip of 16 mm stock from selectively the same length traveling selectively in opposite directions providing 12 mm, or half, of the vertical recording/emulsion area of the full visual capture zone. This represents an overall final, digitized key frame containing over 18 k of data from 16 mm capture. Further, with one key per second being generated on film only, the overall recording area of a single 400 ft roll of conventional 16 mm film stock is still increased to 20 minutes over conventional 24 fps below “2 k” capture, doubling the overall film recording time while increasing image quality approximately 12 fold. This is indeed significant, as film making logistics and methods are not compromised, equipment is not noticeably modified, in weight and selectively in configuration, and there is not only not a demand for more media in providing profound increases in visual quality, but a need for less, e.g., half in this example application.

Again, the horizontal gate configuration would place the strips of emulsion selectively in contact, or very close proximity to each other, one over the other. The selectively variable recording area of the horizontal gate area, would expose selectively images from 4 perforations wide (for TV ratio) to 6 wide, (for 1:85 cinema) and up to 8 perforations wide for providing images of 2:35 (wide screen) ratio, which is remarkably a final image data per visual result of approximately 23 k, from 16 mm stock with recording time still improved per roll, at nearly 16 minutes.

It is important to mention, a key aspect of the proprietary software of the present invention would be the digital means to “eliminate” the fold or “missing data” of the small gap occurring between the two strips of film. The digitally originated images would contain all the data necessary, (at 2 k resolution) for example, for seamless allocation of the “halves” of image data from the film stock, as a small line of “2 k” image resolution marrying halves of much higher resolution, would not be jarring or noticeable. Further, an aspect of the present inventions software would selectively involve extrapolating acceptable “transition” image data between the separate halves of film stock, e.g., captures, for seamless final visuals from the system of the present invention.

An improved aspect is that to expose the emulsion areas detailed herein, no moving optics or moving “gate” aspects need be employed, as both strips of emulsion are exposed simultaneously: Herein 16 mm double strip provides the resolution of single strip 35 mm horiz. 8 perf.

Increasing Quality and Recording Time Of Digital Image Capture

A variety of configurations and options related to hybrid cameras are provided for imaging that allow for increased quality, recording time and other advantageous aspects for entertainment imaging, such as for cinema and television and other motion media.

In one aspect, one media captured selectively simultaneously with aspects of another media capture is used to affect the latter:

An all digital hybrid configuration is disclosed herein, for the purpose of extending the resolution, and amount of overall data per visual, possible to capture, for both still photography and motion media.

In a further aspect of the invention, a high definition digital camera captures selectively both a full visual capture of a lens image, and selectively through the same lens portions of the lens image in higher resolution, wherein the portions are captured for the purpose of affecting, or being affected by, the full visual capture, which was selectively of a lower initial resolution.

For example, one configuration of this invention involves a standard or “normal high definition” video (digital) capture of an image being delivered through a camera lens. This is selectively provided by “video tap” configuration, deriving the image capture from only a portion of the lens image, and selectively also this full visual may be captured through its own independent lens, as a part of a single camera with multiple lenses, or as a separate camera altogether configured to work in tandem with the unit capturing the “higher definition portions of the visual for later applications with/by the full visual capture.

In a further configuration, wherein all visuals are delivered through a single lens, the full visual capture is garnered from a selectively minimal portion of the lens image, requiring only a small portion of the “light” or overall visual information gathered by that lens, for proper rendition of the lens visual in the aspect ratio selected, (such as 1:66 to 1, or 1:85 to 1.)

This initial full visual capture may occur via familiar CCD or other “chip” or other single or multiple electronic capture means familiar with digital image capture, and recorded on tape, on a drive, or relayed for electronic transmission or any selected means for recording and/or relaying the digital data captured.

Time code associated or other visual labeling/tracking data means is provided and maintained/recorded relative to each visual of the full visual captures, for later use as an aspect of the present invention, and the objective of the present invention to end with modified digital visuals representative of the full visuals captured, though with overall resolution, and/or overall image data per visual, beyond what is conventionally possible.

A “subsequent” image capture means from the lens image, selectively the same lens that provided the full visual captures described above, involves a selectively high definition capture means, such as a 4 k digitizing chip(s) device(s,) or other means for capturing visuals of recognizably high photographic or cinema-graphic resolution. However, herein means for providing over a selective period of time, such as a second, only a portion of the lens image, not the full visual captured by the initial (or other image capture means of the present invention,) to the chip(s)/digitizing means. And, this means for providing a portion of the lens image further comprises means to subsequently provide a separate, selectively overlapping or not, portion of the lens image.

In a configuration of the present invention, the “chip(s)” or digitizing plane/means is not flat, but is cylindrical or of a circular or round shape, to allow it to moved, relative to the lens. Further, more than one “chip” or imaging plan/means may be involved in this “cylinder”, or unconventional digital capture surface/means, allowing a second “capture” or another portion of the lens image to occur seamlessly and quickly after a previous image portion capture, so that in the course of a second of time, for example, one or more moving “chips” or image capture means, may be provided with new portions of the lens image to provide, for example, a 4 k capture means with a plurality of new lens image portions (of visual data) resulting in a series of visuals that in tandem, may, for example, represent a composite of image-portion captures of a single lens image that when “assembled” into a single visual, may represent a single visual with, for example, 20k, 40k or even 120k of digital data, selectively per visual and/or selectively per second of digital video.

Selectively, the full visual capture, itself, for example, a 4k, or even 2k, or even lesser amount of data per visual, may in post production and by way of time-code reference, be used as a “template” for assemblage of the plurality of “4k”, for example, captures of portions of the full lens image. This template provided by a full visual capture, selectively captured at 24, 29.97 or other typical digital video capture rate of visuals per second, thus contains useful image position data for an entire second of digital motion visual data, for the plurality of very high resolution image-portion captures to be “applied to.” Reciprocally, this process can be stated as the high definition image portions being assembled into a seamless mosaic with image aspects informed, position wise, by the full visual captures, thus the image portion captures are affected, rather than the full visual captures being affected. In essence, how this interdependence of visual data is “stated” does not change the aspect that they are used in tandem to create final digital visuals, either for still photography, a single visual, or for motion video, at 24 fps frame rate, for example, that are of a very high level of digital data overall, such as 12 k, 20 k, 120 k, employing morphing technology, selectively, and/or the full visual captures to “position” the image portion captures' position, and visual aspects therein, as those image portion captures precluded likely, in an among themselves, the proper capture of overall image-aspects positioning information that was captured, or potentially captured, by conventional full-visual captures, at 24 fps for example.

The lens image may be diverted in part to provide the full visuals' information for capture, prior to optical or other means for focusing enlarging and/or delivering, selectively smaller portions of the overall lens image to the secondary recording means, such as the 4 k option mentioned above, and further with means to revise and/or move to deliver a new portion of the full lens image for subsequent capture.

Time code thus, in conjunction with “image zone” reference data, corresponding to the “zones” of the lens image a given capture represents, would result for example, in one second of image data, involving 24 digital visuals from the initial full visual captures, and selectively 24 “image portions” captured and referenced according to their image zone data, resulting in a “single” composite visual of, for example, 24×4 k, or 96 k; when this “single visual” of data, captured over the course of a second of time is applied to the 24 frames of full visual captures data, selectively employing morphing and/or other digital blending technology, and relying on the full visual captures to modify position of the very high definition visuals' aspects, such as selectively identifiable image zones representing objects and/or image portions distinguished according to selected criteria such as color variation or other means to distinguish image zones, the result is a seamless second of modified digital visual data representing 24 visuals, each 96 k, and all or most modified according to image-zones' position to allow the very high definition “composite” of image zones' data to selectively match the true image zone's position capture through the second of time, represented by the 24 frames of full visual data captured during the same second that the image portions were individually digitized. By making use of the highest information digitizing means, and means to reposition image data based on peripheral data, such as the corresponding full visual captures, a composite of available technologies combined with the new options herein, result in a significantly enhanced resolution capture means.

As with rotating drums in a photo-copying system, and other imaging systems, herein a selectively “moving” delivery of the lens image as opposed to a static delivery of a full lens image, to a selectively moving and/or selectively different capture means, such as 4 k CCD(s), a single lens may provide all of the visual information necessary to capture an extreme level of visual information related to a single lens image-digital repositioning and modification means, (as proprietary software of the present invention, may provide new all-digital video camera systems with resolution and/or overall data captured being a selective aspect, based on “how many” separate image zone captures and how much data the capture means may handle. For example, a 2 k image capture means wherein only three image zones are separately recorded each second, would result in a 6 k imaging system, using the full visuals capture option to affect the 2 k image portion captures, wherein only a maximum of 2 k image capture technology is needed.

By focusing the maximum image capture means/technology to selectively changing portions of a single lens image, it is possible to provide the image data necessary for compatibility with the image management and/or screening systems of “tomorrow.” Meaning, if 96 k is the “projection” capacity of theatres in 10 years, today, in one aspect of the present invention, means exists to capture image data to allow for a final sequence of digital visuals, each containing and exploiting the 96 k data means, and resolution, that will make projects “tomorrow” for use; naturally if a “film” exists as 4 k, and the screening capacity in a few years is 96 k, if a film were even possibly “assembled’ or revised to contain more than 4 k, such as 48 k, or 96 k, the use of that film or project and appeal of it technically will be enhanced in the future, increasing it's long-term value and possible application and viewing life.

An example application, may involve as simple a scenario as a static, flat chip(s) or other image digitizing means, positioned in line with the capture lens; or selectively a digitizing means with limited repositioning means, such as “tilting” left to right, a selective amount relative to the lens image. As the lens image is provided to the image digitizing means, such as chip(s),) an optic element, mirroring, prism means or other image diversion/delivery affecting means, provides selectively ⅓ of the lens image, left to right for example, then the next third, then the next. Then, selectively, the thirds may be provided relative to the next second of visual data, for example, the in reverse direction, right to left. The image portion selecting or diverting/delivery means, may be a rotating mirror or prism, for example, which is returned to the “first third” of the image, automatically, by virtue of it's repeating motion and position; such as a prism being back to it's original position, after it rotates 360 degrees.

Thus, a selectively fluid, if both lens image diversion means and capture means move, capture of different, subsequent aspects of the same lens image, may occur. Or, if the image diversion means has an intermittent motion, stopping three times for example, as a new portion of image is delivered to a static image digitizer, such as a CCD for example, a 4 k digitizing means may provide 12 k of image data relating to the lens image, per second for example,(one complete visual composited, which may be used to affect 24 full frames of visual data, in essence “upgrading” the resolution of 24 “2 k”, or lesser resolution, visuals to 24 “12 k” visuals, employing the single, composited/mosaic of 4 k image data representing distinct portions of the lens image, all occurring in lesser resolution within the full visual data of the conventional, e.g., “video assist” or primary capture stage of the invention, digital images captured.

Aspects of the invention include: How many distinct image portions of the lens image are digitized per second; How much they overlap with each other; How many conventional full visual digital images are captured per second; whether the lens, secondary optics and/or the digitizing means, chips or other means, move, are all selective options. The primary issue affecting the choice of these options is the eventual display system(s,) both in regard to resolution, aspect ratio and frame rate.

The objective is to create digital visuals of resolution exceeding the capture resolution of available “full visual” digitizing means. The software options making this feasible include means to affect visuals of the same, or similar, images, by way of time code, and other data options, cross referencing and in regard to image aspects that are identified to correlate: Lips moving over the course of a second, in a the continuous full visual images captured, 24 of them for example, may be enhanced in resolution in all 24 visuals thus, as though each portion of the visual has only a single high-high resolution reference, it is possible to extrapolate that the lips moving, as they “smile” maintain the additional digital data in the high-high resolution composite visual, or mosaic, only in slightly revised positions, informed by the actual position shifts of visual aspects recorded in the conventional full visual digital images.

Again, the mosaic of high-high definition data, creating for example a single frame of visual data per second, may upgrade all 24 frames of corresponding video captured, full visuals, during the second that “single frame” of high-high definition information was captured, resulting in the single reference, or “key frame” of visual data.

The selective capture of a key frame of visual data from a portion of the lens image diverted from another portion, used to capture more conventional digital data, such as 24 fps of 2 k digital visuals' data, is created at a selectively lesser capture rate, such as 1 overall total visual per second, for the express purpose of being used in affecting and modifying the more conventional digital material captured for a specific objective/reason, to “recolor” aspects/zones of the visuals to correspond to the “filmed color rendition” of those same image zone aspects; in the invention herein, to upgrade the more conventional full visual captures to a higher resolution, even a resolution higher than any full-visual capture means existing may allow, through digital application of the assembled key frame “mosaic” representing a single visual captured during the time a number of visuals were captured by the more conventional full visual means.

Again, digital image zone correlation and modification means, and even familiar morphing technology, make the present invention timely, feasible and logical; hybrid technology points the way to modified digital visuals, both in the simulation of preferred “looks”, acting-as-if a selected film stock had been the original recording media overall, and in the simulation of enhanced resolution, acting-as-if a very high resolving digitizer had been used to capture the full visuals, even one surpassing by far those presently existing.

Quality and Resolution of Hybrid Film and Digital Cameras

In a further embodiment a hybrid film and digital cameras are provided wherein the media is configured in tandem for the purpose of capturing visuals with the visual quality of film and with a resolution amount of visual information surpassing conventional image capture utilized today:

A film camera capturing a visual through a single lens, which is “split”, visually fragmented by a beam splitter of other lens-light diverting/dividing means, remains in the conventional film configuration of film stock and magazine containment. With regards to a 35 mm motion picture camera, such as PanaVision units, this means a magazine positioned on top of the camera, film which is delivered vertically to a gate for exposure and returned to the “take up” reel of the film magazine containment.

What is altered in the present configuration, related selectively to the optics and/or gate, or exposure area, of the film camera. Further, the digital or electronic picture capture aspect of the hybrid camera is high definition digital, with image quality similar to that of digital cinema units, such as the Sony CineAlta camera.

Herein, selectively variable aspects of the optics occurring selectively after the lens image has been in part diverted to the digital capture unit, or other flickerless “video assist” aspect allowing for electronic capture of the lens image, focus a portion of the lens image only to the film plane, for film emulsion recording intermittently within the film gate. Selectively the digital visual capture may occur through a separate lens, or other stage of the single lens capture process, in this configuration however a portion of the lens image is diverted for digitizing prior to the secondary aspect/process of the present system method's optics. However, conventional “video assist” options, such as the relaying of the lens image during the intermittent motion of the film, when the film plane is not receiving the lens image, may be employed selectively herein, allowing for conventional flick-free digital capture to couple with selectively conventional film capture process.

The difference herein, toward the objective of increased capture resolution, involves the delivery of a selectively different portion of the lens image to the film plane, to subsequent unexposed portions of emulsion (moved into the gate intermittently, as is conventional. As with a “zoom lens” where focal changes deliver a selectively different portion of the total possible lens image or scene to the film plane, herein at a selectively conventional 24 fps, or slower rate, even 2 fps, for example, selectively different portions of the overall lens image are delivered automatically to the film for recording, frame after frame. For example, in a simple configuration of the present invention, an image being originally captured at a given focal setting is delivered by lens optics toward the film plane for recording. Herein, selectively variable and/or moving optical elements, provide an amplification of what would have been the normal visual headed for the film plane, providing selectively half of the full lens image to the 35 mm film plane, and then after intermittent transport of the film to the next portion of unexposed motion picture film, selectively the other half of the lens image is provided to the gate and film plane for recording.

In this system and method, instead of a single lens visual being recorded at one instant onto a selected piece of emulsion, the lens image is delivered in stages two in this example to separate pieces of emulsion, allow for distinctly different recorded visuals to occur within two sequential frames of film emulsion, overlapping in visual content. Herein, digital means or other means, may be employed in post production to create a single visual, representative of the full lens image (delivered to these variable optic aspects, or other electronic image delivery and varying means,) from the sequential film frames.

What is gained, herein, is visual quality. When a wide-screen cinematic visual is initially recorded by a 35 mm camera, for example, the emulsion available for the visual is limited by the width of the film stock. Typically, in a camera not anamorphically altering the scene captured, the wide visual occupies less film emulsion, than even a typical filmed television show capture means; this is because the ratio of the display means for a television show is more “square” allowing for more of the “4 perf’ emulsion area to be utilized in capturing a single visual. Thus, ironically, significantly less emulsion is used per original scene/image area, when capturing a visual for a large screen display means, such as a 1:85 to 1 cinema screen, than is used when capturing a visual for a small screen (1:33 to 1) television display intent.

The entire emulsion surface area found within 4 perforations (vertically) of 35 mm film, may be utilized in recording a selected portion of the lens visual that would have been delivered in it's entirety to a single frame of film. So, in one example, the variable optics may provide 12 or less representation of the “left side” of the lens image that would be have been recorded on a single frame of film, and 12 or less representative of the “right side” of the lens image. Thus, in this example, a visual of as wide or wider than the cinema screen ration 2:35 to 1, may be captured within two subsequent frames of 35 mm motion picture film, providing a final visual, if the “sides” are married in digital post production, for such wide screen display means stored initially within an overall emulsion surface area many fold that which would have been utilized in capturing such a lens image, conventionally. This affects image quality.

Further, not being limited to horizontal, or left to right, partitions of lens images, sophisticated variable optic means may provide, for example, 12 separate portions of a lens image, or less, or more, with portions of the lens image coming from different areas both horizontally and vertically within the original lens image. Such a capture system then provides, from a single second of recording for example, 24 frames of high definition, or regular definition, digital visuals captured by the electronic capture aspect of the hybrid camera, such as the well known “video assist” aspect, and 24 frames of 35 mm picture film, wherein selectively the configuration capturing two frames of 4 perf visuals for each overall framed scene visual, resulted in a visual quality, e.g. emulsion, more like 70 mm film capture. In a scenario where in 12 frames of film, if running at 12 fps, wherein a selectively unique portion of the lens image is delivered to each frame, an imaging result may exceed any currently known approach to capturing images for entertainment.

In that scenario, the mosaic of captures from portions of the overall image, provides a final emulsion surface area, per visual, that is enormous; in essence, as large as all 12 frames' recording area pasted together, more like still photography's 2¼″ negatives.

In post production, by way of existing morphing technology and selective digital replacement means, the digital images or video captured may selectively provide all of the image elements' positioning data necessary to apply the filmed image, once assembled as one, digitally for example, per second, to the 24 frame of originated digital material. As a result, for future display, and current very high resolution display means, the large “key frames” of data, created by different subsequent frames of film that in tandem represent a single “scene” being photographed, provide all of the original visual data necessary for display systems of the future, that may exceed even 30 k, for example.

In one aspect of the invention is disclosed a relatively unchanged camera configuration, with optics including means to isolate distinct portions of a scene, through a lens, for subsequent recording on a film stock. When digital assembled, and selectively utilizing conventional digital visuals originated of the full scene framed, the image “portions” recorded on film provide an increased emulsion recording size of a selected amount, for selective digitizing and assemblage, in association with the digitally originated material, or not.

In a further aspect, 24 frames of digital material captured, may be selectively applied to the extremely high resolution overall visual resulting from (even 24) distinct 35 mm frames representative of a single “scene” framed by the cinematographer. Therein, though somewhat absurd at the present, perhaps less so in the future, morphing and image aspect repositioning means may provide post production software to allow those 24 distinct captures from a single scene to result in 24 frames of the full scene, provide by the full frame original digital captures, with the potentially more than 6 k of data per film frame resulting in 24 overall frames of motion media, each and every of those 24 frames containing potentially over 140 k of data.

Though the uses for 140 k images may be limited today, the availability of the ability to extract such image quality from entertainment projects shot today may affect such projects' compatibility and use in the future-wherein projects limited to 4 k, for example, may be less desirable for systems and audiences geared to much higher quality future systems of viewing.

Again, in the simplest configuration, a single 2:35 to 1 ratio visual, for example, may be captured within 24 frames of 35 mm emulsion as 12 “left side” portions of the framed scene, and 12 “right side” portions, (recorded in staggered order, left, right, left, right, selectively.

24 frames of video material captured in tandem with the filmed images, even “video assist material”, may be referenced or employed in allocating the “sides” of filmed visual data, once digitized for example, to assemble 24 final digital images with selectively an image quality exceeding 12 k, and likely approaching 20 k, considering the efficient use of the 4 perf emulsion area.

In essence, the 35 mm cameras of today may provide approximately 70 mm originated cinema images, meaning images similar to those captured with 65 mm or 70 mm “equipment” and film stock.

16 mm cameras, for example, with the hybrid configuration, purpose and means herein, may provide final visuals well in excess of conventional 35 mm cameras today. And, in any gauge size, while selectively extending the recording time of the film media. For example, if a lens image or scene is captured on film as 6 distinct areas, or portions, totaling the full scene, that is 6 fps. So, the net effect is while increasing image quality by at least 6 times, over conventional 16 mm capture, the recording time of a single roll of film is quadrupled, as film is running at ¼ the normal frame rate; as film is capturing reference frames, while the digital aspect of the hybrid unit is capturing full frame visual data, including critical image data relating to the shifting or changing or repositioning of elements recorded during a single second, that may have been “missed” by the filmed frames.

Thus, digital technology allows for the higher resolution of the single assembled film frame, to not be compromised in repositioning those higher resolution “elements” relative to their counterparts within the digitally originated visuals. Thus, nothing is compromised in resulting in digital images, with the “look” of film, with virtually unlimited resolution and wherein film recording time is simultaneously extended dramatically.

Although the foregoing invention has been described in some detail by way of illustration and example for purposes of clarity of understanding, it will be readily apparent to one of ordinary skill in the art in light of the teachings of this invention that certain changes and modifications may be made thereto without departing from the spirit or scope of the appended claims.

What is claimed:

1. A composite media recording element comprising,
at least two recordable information components operable to store and subsequently provide mutually dependent information related to selected portions of at least one final image,
a plurality of said information related to selected portions including image information necessary for recreating said at least one final image,
a first recordable information component storing image data, said image data stored in response to aspects of an initial light stimulus related to a visual, said final image being a representation of at least one aspect of said visual,
a second recordable information component linked to said first information component, storing non-image data related to said image data, said non-image data related to positioning within a specific final image of said image data,
said non-image data encoding selected aspects of the physical position of at least said first image information recording component during response to aspects of said initial light stimulus, and
said mutually dependent information provided within said element further identifying the final image relevant to all of said information stored within said element, at least when elements related to different final images are not physically separated to distinguish said different final images.

2. The composite media recording element of claim 1, wherein said element is one of a plurality of elements comprising image information related to an entire final image, said plurality of elements presented in a motionless state, relative to each other, during initial storage of image data as a function of reaction to an initial light stimulus, said elements being unfixed particles of a selected size capable of shifting position relative to each other when affected externally, said elements remaining unfixed at least during image capture, wherein elements are provided for exposure and data storage in reaction to said light stimulus and following repositioning of elements storing information following said exposure.

3. The composite media recording element of claim 2, wherein said repositioning alters a position of said elements relative to each other.

4. The composite media recording element of claim 1 wherein at least one of said information storing components is a photographic latent image recording emulsion.

5. The composite media recording element of claim 1 wherein at least one of said information storing components is an electronic recording material.

6. The composite media recording element of claim 5 wherein at least one of said information storing components is a magnetic recording material.

7. The composite media recording element of claim 1 wherein said information storing components are in an unfixed state before and after exposure, said non-image data providing subsequent reference to positioning of image data within a final image, said image data related to said element, said subsequent reference representing at least one cooperative aspect of said mutually dependent information.

8. The composite media recording element of claim 1 wherein said image information recording component is exposed to said light stimulus to store said selected portions of at least one final image, and further comprising a camera operable to manage a plurality of said elements to and from an exposure area, affecting each element distinctly to store at least some of said mutually dependent information.

9. The composite media recording element of claim 8 wherein said exposure area is of a selectively large size and ratio, said size and ratio affecting the volume of elements provided to said exposure area.

10. The composite media recording element of claim 1, wherein said elements include only photographic emulsion as the recordable components, said emulsion being recordable over substantially the entire three dimensional surface of said element, said image and non-image data being recorded within said emulsion.

11. The composite media recording element of claim 10 further comprising a third component comprising a core for said emulsion to coat, said third component is related to a shape of an element structure.

12. The composite media recording element of claim 8 wherein said camera is operable to provide physical affecting means to provide said plurality of said element.

13. The composite media recording element of claim 12 wherein said physical affecting means involves a release of compressed gas.

14. The composite media recording element of claim 12 wherein said physical affecting means involves electronically affected repositioning means of substantially each element.

15. The composite media recording element of claim 14 wherein said physical affecting means are magnetic repositioning means.

16. The composite media recording element of claim 12 wherein said element is fixed to a containment following removal of said element from said camera for stabilizing said emulsion related to said element for photochemical processing.

17. The composite media recording element of claim 1, further comprising a computer operated data managing program for applying said mutually dependent information in creating final images from information stored within said components, said non-image data distinguishing image data relative to corresponding final images and final image aspects to which said image data relate.

18. A composite media imaging system comprising,
at least two information storing components operable to store and subsequently provide mutually dependent information related to selected portions of at least one final image,
a plurality of said portions relating to image information necessary to recreate said at least one final image,
one of said information storing components storing non-image data related to said final image, said non-image data related to positioning of image information recorded within an image information recording component of said system, wherein said information storing components are linked to provide said mutually dependent information related to said final image,
said non-image data encoding selected aspects of the physical position of said image information recording component during initial image information recording within said recording component, and further identifying the corresponding final image to which said image data pertains, when said components occur within a plurality of components related to a plurality of final images, and
a computer operated data managing program to apply said mutually dependent information in creating final images from information stored within said components.

19. The system of claim 18 wherein at least one of said information storing components comprise photographic emulsion.

20. The system of claim 18 wherein said information storing components comprise an electronic recording material.

21. The system of claim 20 wherein said information storing components comprise a magnetic recording material.

22. The system of claim 18 wherein said information storing components are distinct particles of a selected size, said particles occurring in an unfixed state before and after exposure.

23. The system of claim 18 wherein said image information recording component is exposed to light to capture said selected portions of at least one final image, and a camera managing the transport and exposure of said image information recording component, said camera affects the information storage component to store the non-image data related to the mutually dependent information being captured.

24. The system of claim 23, further comprising an exposure area within said camera of a selectable size affects the volume and dispersal of said components by said camera to and from said exposure area.

25. The system of claim 18 wherein said information storing components are in an unfixed state before and after initial recording, said initial recording including exposure to a light stimulus representing a visual.

26. The system of claim 18 wherein said components are provided as aspects of an element, each element operable to store image and non image data and to subsequently provide a computer operating distinct image data managing software with sufficient information to distinguish the equivalence of at least one pixel of image information and to further distinguish a selected final image and placement within said final image where said pixel should be placed, within a final image.

27. The system of claim 18 further comprising a camera operating in tandem with a distinct data generating assembly, a stimulus affecting said assembly generates at least information related to the position and shape of selectively distinguished image zones represented within said mutually dependent information recorded by one of said components storing image data, wherein said information related to position and shape pertains to exposure periods occurring when none of said components are being affected by said camera to store said mutually dependent information,
said assembly providing intermediary positioning of said zones not available within image data of said element for extrapolating image information not stored within said components,
said extrapolating at least involving computer modification of image data based on data recorded by said assembly when image information was not being captured, and
said assembly sampling at least one aspect of a full visual related to at least one final image, said sampling occurring selectively more frequently for each portion of said visual than information recorded within said components, relative to said each portion.

28. A method for imaging comprising,
providing at least two information storing components operable to store and subsequently provide mutually dependent information related to selected portions of at least one final image, wherein a plurality of said portions relating to image information necessary to recreate said at least one selected final image,
storing non-image data related to said final image in one of said information storing components, said non-image data related to positioning of image information recorded within an image information recording component of said system,
linking said information storing components to provide said mutually dependent information related to said final image,
encoding selected aspects of the physical position of said image information recording component in said non-image data during initial image information recording within said recording component, and identifying the corresponding final image to which said image data pertains, at least when said components occur within a plurality of components related to a plurality of final images, and
applying said mutually dependent information in a computer operated data managing program to create final images from information stored within said components, said non-image data distinguishing image data relative to corresponding final images and final image aspects to which said image data relate.

29. The method of claim 28 wherein said linking of said components occurs as a physical joining of said components into elements, said elements being particles of a selected size and shape.

30. The method of claim 29 wherein said elements are unfixed particles operable to be repositioned by a camera functional to affect said elements, said camera affecting repositioning of said particles randomizing the position of said particles relative to each other during each repositioning.

31. The method of claim 28 wherein said information storing components are in an emulsion.

32. The method of claim 28 wherein said information storing components are a magnetic recording material or an electronic recording material, or a combination thereof.

33. The method of claim 28 wherein said information storing components are in an unfixed state before and after exposure.

34. The method of claim 28 further comprising exposing said image information recording component to light to capture said selected portions of at least one final image, wherein the camera affects the information storage component to store the non-image data related to the mutually dependent information being captured.

35. The method of claim 28 wherein at least one of said information storing components comprise photographic emulsion.

36. The method of claim 28 wherein said information storing components comprise an electronic recording material.

37. The method of claim 28 wherein said information storing components comprise a magnetic recording material.

38. The method of claim 28 wherein said information storing components are in an unfixed state before and after initial recording, said initial recording including exposure to a light stimulus representing a visual.

39. An imaging system for tandem capture of information related to one or more final images comprising,
an image information collection and recording device for providing stimuli related to a visual to a first media capture module, said module capturing aspects of said stimuli as image information, and
one or more second media capture modules for capturing additional information related to aspects of said visual, wherein said first or second module comprise linking data to selectively link distinct information gathered by the modules to inform a computer-operated image data managing program to generate final images related to said visual.

40. The imaging system of claim 39 wherein some portion of said additional information is captured during time periods in which said first media capture module is not operative to capture information.

41. The imaging system of claim 39 wherein said second module is positioned independently from said first module, gathering information not available for capture from the position of said first module, including information related to aspects of said visual at least partially represented within information captured by said first module, said information related to aspects affecting selected distinctions between final images and images represented by information captured by said first module.

42. The imaging system of claim 39 wherein at least said second module is one of a plurality of devices operating to generate data related to at least stimuli received by said devices representative of at least one aspect of said visual represented within information captured by said first module, said devices operable to be positioned within an area represented within said visual captured by said first module, including positions intentionally visually blocked by visual aspects allowing said devices to provide information affecting final images that do not reveal visually said devices within the visual information captured by said first module.

43. The imaging system of claim 39 wherein at least said second module may generate and receive transmitted signals that allow said second module to generate data unique to the position of said second module and selectively linked to corresponding image information captured by said first module, all linked module information informing computer generated final images.

44. The imaging system of claim 39 wherein said first module is a camera for generating key frame image information related to said visual, each key frame image generated providing primary image data related to a plurality of final images, said devices capturing at least some data related to generating mutually unique final images that are based on a single key frame image.
